(19) United States
(12) Patent Application Publication
(10) Pub. No.: US 2018/0312790 A1
(43) Pub. Date: Nov. 1, 2018

(54) HOLLOW BATH AND HAND SOAP BAR SHELL WITH A HOLLOW INSERT OF NON-SOAP MATERIAL LOCATED WITHIN ITS CORE

(71) Applicant: Sanjeev Kumar Singh, Alpharetta, GA (US)

(72) Inventor: Sanjeev Kumar Singh, Alpharetta, GA (US)

(21) Appl. No.: 15/583,280

(22) Filed: May 1, 2017

(51) Int. Cl. C11D 17/04; C11D 13/16

(52) U.S. Cl. CPC C11D 17/048; C11D 13/16

(57) ABSTRACT

A bath or hand soap bar shell is provided with a hollow insert of a different material is positioned within the core of the shell such that the hollow insert is fully buried in the soap material. This bath or hand soap bar shell substantially reduces a weight of the shell as compared to a solid soap bar so that when the shell is trashed without its full use the waste of the soap material is significantly minimized. In one embodiment, the bath or hand soap bar shell comprises a first soap portion formed from a first meltable soap material. The bath or hand soap bar shell further comprises a hollow core insert formed from a second material. The second material is different than the first meltable soap material. The bath or hand soap bar shell further comprises a second soap portion formed from the first meltable soap material, the second soap portion applied to the first soap portion such that the bath or hand soap bar shell fully encases the hollow core insert.

### BACKGROUND

### 1. Field

Aspects of the present invention relates to soap bars commonly used for human bathing or hand cleaning, and more particularly, a hollow soap bar shell with a non-soap material insert.

### 2. Description of the Related Art

Soap bars are commonly used for human bathing and a variety of cleansing tasks such as hand cleaning. Unless you plan on holding up in a hotel room for an extended period of time, it's safe to say that complimentary bar of soap won't get used up. But where does that soap go after the hotel guests are gone.

In the hotel industry, it is common to provide a fresh bar of bath soap for each new hotel guest. Some luxury hotel brands also commonly provide a fresh bar of bath soap each day, even for a multi-night stay. The resulting disposal of the bath soap used the prior day creates an undesirable waste stream which must be disposed or recycled.

At least some of soap bar waste from the hotel industry goes to a company that recycles the soap to make new soap. The soap they use never reaches the landfill, helping the local environment and all of the new soap is distributed to areas of need. Hotels actually pay the recycle company to take their unused soap—$0.50 per room, per month. The soap is melted down and reformed into new bars. These new soaps are packaged and sent off to charities around the world.

Bath soap however, which is commonly provided as a convenience to hotel patrons, creates unnecessary waste when it is disposed after only one or a few uses. Because the lathering and cleansing process involves removal of soap material from only the surface of the bar of soap, the interior solid core soap material is not consumed during a single or few uses, thus becomes a waste when it is no longer desirable to use the soap. This is commonly the practice when hotel patrons bath once or twice in a hotel room shower and then check out of the room and depart. The hotel housekeeping personnel discard or recycle the remaining soap bar as waste, prior to the arrival of the next guest, who expects a fresh bar of soap. This is often done to convey a quality appearance and to promote good personal hygiene.

Therefore, a soap bar overcoming various problems and shortcomings of the prior art would be an important improvement in the art.

### SUMMARY

Briefly described, aspects of the present invention relate to a soap bar which minimizes resulting waste at the end of its useful life. This soap bar does not focus on subsequent recycling of soap bar remnants as a very minimal reusable structural core left to recycle. Because the lathering and cleansing process involves removal of soap material from only the surface of the bar of soap, the interior hollow core soap or non-soap material is not needed to be consumed during a single or few uses.

In accordance with one illustrative embodiment of the present invention, a bath or hand soap bar shell is provided. The bath or hand soap bar shell comprises a first soap portion formed from a first meltable soap material, a hollow core insert formed from a second material, wherein the second material is different than the first meltable soap material and a second soap portion formed from the first meltable soap material. The second soap portion is applied to the first soap portion such that the bath or hand soap bar shell fully encases the hollow core insert.

Consistent with another embodiment, a method for producing a bath or hand soap bar shell is provided. The method comprises pouring a meltable soap material into a mold cavity, forming a first soap piece in the mold cavity from the meltable soap material, positioning a hollow core insert formed from a non-soap material on the first soap piece, pouring the meltable soap material into the mold cavity to form a second soap piece and applying the second soap piece to the first soap piece as a molten soap material forming an adhesive interface therebetween when the first soap piece and the second soap piece are brought into contact with each other.

### BRIEF DESCRIPTION OF THE DRAWINGS

FIG. 1 illustrates a perspective view of a bath or hand soap bar shell provided with a solid hollow insert of a different material than a soap material of the shell in accordance with an exemplary embodiment of the present invention.

FIG. 2 illustrates a cross-sectional view of the bath or hand soap bar shell of FIG. 1 at an axis A-A′ in FIG. 1 wherein the shell is made from a first process according to one embodiment of the present invention.

FIG. 3 illustrates a cross-sectional view of the bath or hand soap bar shell of FIG. 1 at an axis A-A′ in FIG. 1 wherein the shell is made from a second process according to one embodiment of the present invention.

FIG. 4 illustrates a cross-sectional view of the bath or hand soap bar shell of FIG. 1 at an axis A-A′ in FIG. 1 wherein the shell is made from a third process according to one embodiment of the present invention.

FIG. 5 illustrates a schematic view of a mold for forming a bath or hand soap bar shell from two pieces whereas a meltable soap material has been filled into the mold according to one embodiment of the present invention.

FIG. 6 schematically illustrates the step of positioning a hollow core insert formed from a non-soap material on a first soap piece according to one embodiment of the present invention.

FIG. 7 schematically illustrates the step of pouring the meltable soap material into a mold cavity to form a second soap piece according to one embodiment of the present invention.

FIG. 8 schematically illustrates the step of applying the second soap piece to the first soap piece according to one embodiment of the present invention.

### DETAILED DESCRIPTION

To facilitate an understanding of embodiments, principles, and features of the present invention, they are explained hereinafter with reference to implementation in illustrative embodiments. In particular, they are described in the context of a bath or hand soap bar shell which is provided with a hollow insert of a different material. The hollow insert is positioned within the core of the shell such that the hollow insert is fully buried in the soap material. This bath or hand soap bar shell substantially reduces a weight of the shell as compared to a solid soap bar so that when the shell is trashed without its full use the waste of the soap material is significantly minimized. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

Embodiments of the present invention relate to a soap bar which minimizes resulting waste at the end of its useful life. Because, the soap bar is hollow with 25% to 50% less weight compared to a solid soap bar the resulting disposal of the bath soap used the prior day does not create much undesirable waste stream which must be disposed or recycled. Desirable external dimensions of a bar of soap are large enough to be conveniently held in the user's hand while scrubbing or lathering. Desirable structural properties for a bar of soap are to be strong enough to avoid breakage during the bathing process.

Although some embodiments of this invention may be described and illustrated herein in terms of a two piece shell manufacturing, it should be understood that embodiments of this invention are not so limited, but are generally applicable to any number of pieces. Further, although some embodiments of this invention may be described and illustrated herein in the context of a single cell hollow insert, it should be understood that embodiments of this invention are not so limited, but are generally applicable to any number of cell arrangement.

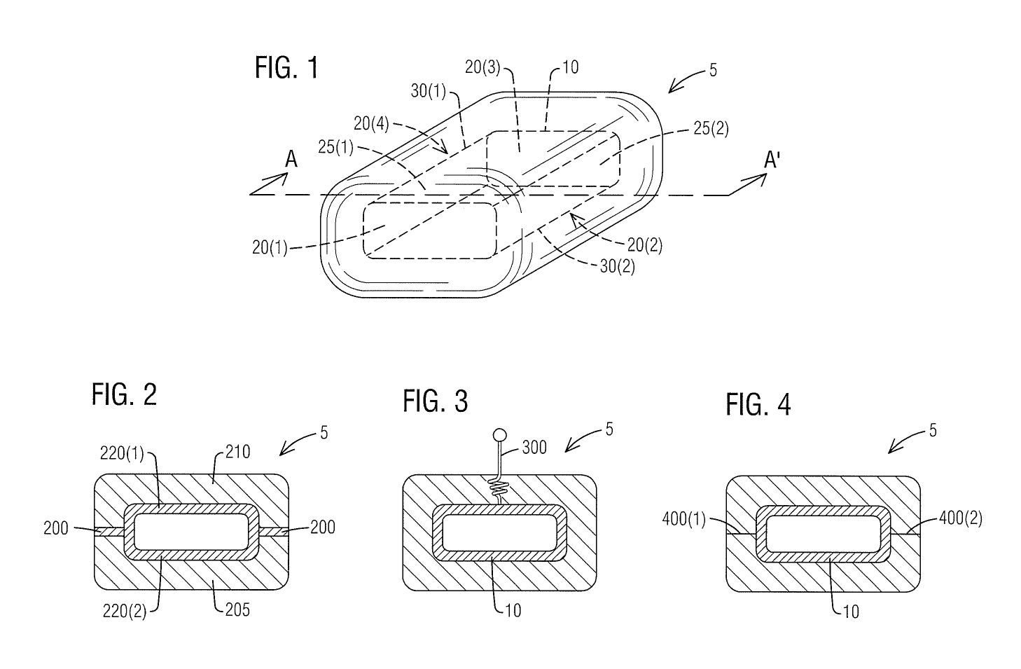

FIG. 1 illustrates a perspective view of a bath or hand soap bar shell 5 including a hollow core insert 10 of a different material than a soap material of the bath or hand soap bar shell 5 in accordance with an exemplary embodiment of the present invention. In one embodiment, the bath or hand soap bar shell 5 is hollow with 25% to 50% less weight compared to a solid soap bar. The bath or hand soap bar shell 5 has external dimensions large enough to be conveniently held in a human user's hand while scrubbing or lathering. The bath or hand soap bar shell 5 has structural properties to be strong enough to avoid breakage during the bathing or scrubbing or lathering process. The bath or hand soap bar shell 5 may have a box shape. Alternatively, the bath or hand soap bar shell 5 may have an oval shape or a round shape.

The hollow core insert 10 is positioned within a core of the bath or hand soap bar shell 5 such that the hollow core insert 10 is fully buried deep in the soap material of the bath or hand soap bar shell 5. This bath or hand soap bar shell 5 substantially reduces a weight of the bath or hand soap bar shell 5 as compared to a solid soap bar so that when the bath or hand soap bar shell 5 is trashed without its full use the waste of the soap material is significantly minimized.

Consistent with one embodiment, the hollow core insert 10 includes a pair of parallel spaced side walls 20(1-4) and a pair of parallel spaced end walls 25(1-2) interconnected to the side walls 20(1-4) to form a quadrilateral planar frame. The quadrilateral planar frame has upper and lower edges 30(1-2).

The hollow core insert 10 is positioned within the core to provide extra strength to the hollow shell structure of the bath or hand soap bar shell 5 as compared to having no hollow core insert. The hollow core insert 10 ensures that the bath or hand soap bar shell 5 does not collapse or break due to pressure applied to it during the bathing or lathering process. To this end, the hollow core insert 10 may be of a certain thickness sufficient to sustain normal human usage force.

For example, the hollow core insert 10 may have a thickness of 1-2 mm and the material of the hollow core insert 10 may be paper, wood or plastic that has some resilience and structural properties. The hollow core insert 10 may be made by any of many known processes which are not detailed here for the sake of brevity. The paper or wood material may be preferred over the plastic due to its low cost benefit and its biodegradable properties.

An empty hollow core insert would have a lesser value than a solid volume of soap material filled in its place in the core of the bath or hand soap bar shell 5. Therefore, the bath or hand soap bar shell 5 with the hollow core insert 10 may be 40%-50% cheaper than a solid soap bar of the same size. This fact would provide hotels with savings on the cost of the soap bars. And even if some hotels may not recycle the leftover soap bars, the loss of soap material will be less since the soap bars would be empty in the core.

FIG. 2 illustrates a cross-sectional view of the bath or hand soap bar shell 5 of FIG. 1 at an axis A-A′ in FIG. 1 wherein the bath or hand soap bar shell 5 is made from a first process according to one embodiment of the present invention. In the first process, the bath or hand soap bar shell 5 comprises at least two portions or pieces joined together with a molten soap material process for an interface 200 between two portions or pieces.

The bath or hand soap bar shell 5 comprises a first soap portion or piece 205 formed from a first meltable soap material. The bath or hand soap bar shell 5 further comprises the hollow core insert 10 formed from a second material. The second material may be different than the first meltable soap material. For example, the second material may be a non-soap material. The bath or hand soap bar shell 5 further comprises a second soap portion or piece 210 formed from the first meltable soap material. The second soap portion or piece 210 is applied to the first soap portion or piece 205 such that the bath or hand soap bar shell 5 fully encases the hollow core insert 10.

Consistent with one embodiment, the hollow core insert 10 includes the pair of parallel spaced side walls 20(1-4) and the pair of parallel spaced end walls 25(1-2) interconnected to the side walls 20(1-4) to form the quadrilateral planar frame. The quadrilateral planar frame has upper and lower edges 220(1-2). The first soap portion or piece 205 is secured to the upper edge 220(1) and the second soap portion or piece 210 is secured to the lower edge 220(2).

In one embodiment, the hollow core insert 10 comprises a single hollow shell. The single hollow shell may be formed with the second material such that the hollow core insert 10 is in a solid form. The second material may be a non-soap material. The non-soap material of the hollow core insert 10 may be a paper or a wood. The non-soap material may be a recycled paper or a paper product. The non-soap material may be a synthetic or a plastic or a plastic-based product.

In the first process, the first soap portion or piece 205 is solid when joined with the second soap portion or piece 210. The second soap portion or piece 210 may be solid when joined with the first soap portion or piece 205. Both the first soap portion or piece 205 and the second soap portion or piece 210 may be solid when joined together. Alternatively, the first and second soap portions or pieces 205, 210 may be formed with a meltable molten soap material when joined.

The hollow core insert 10 may have a volume which is selected to give the bath or hand soap bar shell 5 about 40% to 60% less weight as compared to a solid bath or hand soap bar of a same size. The hollow core insert 10 may have a box shape. Alternatively, the hollow core insert 10 may have an oval shape or a round shape.

FIG. 3 illustrates a cross-sectional view of the bath or hand soap bar shell 5 of FIG. 1 at an axis A-A′ in FIG. 1 wherein the bath or hand soap bar shell 5 is made from a second process according to one embodiment of the present invention. In the second process, a second soap portion is joined to a first soap portion by a molten soap material forming an invisible joint therebetween. The hollow core insert 10 may be placed after layering the first soap portion in a mold. A string such as a cotton thread 300 may be coupled to the hollow core insert 10 to position by hanging and lower the hollow core insert 10 in the mold.

FIG. 4 illustrates a cross-sectional view of the bath or hand soap bar shell 5 of FIG. 1 at an axis A-A′ in FIG. 1 wherein the bath or hand soap bar shell 5 is made from a third process according to one embodiment of the present invention. In the third process, a single soap portion is formed by a molten soap material forming a shell around the hollow core insert 10. The hollow core insert 10 is positioned by hanging it at a middle location in a mold with some hanging arrangement which gets buried after solidification of the bath or hand soap bar shell 5. For example, cotton threads 400(1-2) may be used to tie the hollow core insert 10 to the mold on its both ends.

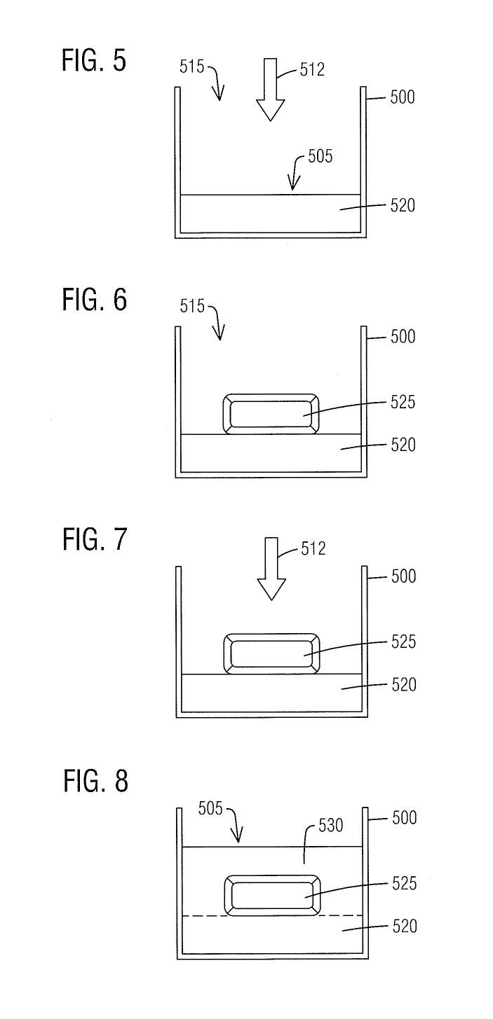

FIG. 5 illustrates a schematic view of a mold 500 for forming a bath or hand soap bar shell 505 (shown fully in FIG. 8) from two pieces whereas a meltable soap material has been filled into the mold 500 according to one embodiment of the present invention. For producing the bath or hand soap bar shell 505, in a first step a meltable soap material 512 is poured into a mold cavity 515 for forming a first soap piece 520 in the mold cavity 515 from the meltable soap material 512.

FIG. 6 schematically illustrates the step of positioning a hollow core insert 525 formed from a non-soap material on the first soap piece 520 according to one embodiment of the present invention. FIG. 7 schematically illustrates the step of pouring the meltable soap material 512 into the mold cavity 515 to form a second soap piece 530 (shown in FIG. 8) according to one embodiment of the present invention.

FIG. 8 schematically illustrates the step of applying the second soap piece 530 to the first soap piece 520 according to one embodiment of the present invention. Applying the second soap piece 530 to the first soap piece 520 includes applying it as a molten soap material forming an adhesive interface therebetween when the first soap piece 520 and the second soap piece 530 are brought into contact with each other. The molten soap material of the second soap piece 530 is melted to a higher temperature than a normal temperature it is melted to so that when it touches the first soap piece 520 it essentially melts it up to a certain depth, making a strong bond of melted soap material which can sustain normal use of the bath or hand soap bar shell 505. The adhesive interface therebetween when the first soap piece 520 and the second soap piece 530 is formed in a molten state of the soap material hence it has sufficient strength to survive a typical usage of the bath or hand soap bar shell 505.

The techniques described herein can be particularly useful for a rectangular or square bath or hand soap bar shell with a box-shaped hollow core insert. While particular embodiments are described in terms of rectangular or square, the techniques described herein are not limited to rectangular or square but can also use other shapes such as oval and round shells and oval and round hollow core inserts. This bath or hand soap bar shell substantially reduces a weight of the shell as compared to a solid soap bar so that when the shell is trashed without its full use the waste of the soap material is significantly minimized.

While embodiments of the present invention have been disclosed in exemplary thin's, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or teens.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise fauns disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Although the steps, operations, or computations may be presented in a specific order, this order may be changed in different embodiments. In some embodiments, to the extent multiple steps are shown as sequential in this specification, some combination of such steps in alternative embodiments may be performed at the same time.

Embodiments described herein can be implemented in the faun of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A bath or hand soap bar shell, comprising:
a first soap portion formed from a first meltable soap material;
a hollow core insert formed from a second material, wherein the second material is different than the first meltable soap material; and
a second soap portion formed from the first meltable soap material, the second soap portion applied to the first soap portion such that the bath or hand soap bar shell fully encases the hollow core insert.

2. The bath or hand soap bar shell of claim 1, wherein the hollow core insert including a pair of parallel spaced side walls and a pair of parallel spaced end walls interconnected to the side walls to form a quadrilateral planar frame.

3. The bath or hand soap bar shell of claim 2, wherein the quadrilateral planar frame having upper and lower edges, the first soap piece secured to the upper edge, the second soap piece secured to the lower edge.

4. The bath or hand soap bar shell of claim 1, wherein the hollow core insert comprising a single hollow shell.

5. The bath or hand soap bar shell of claim 4, wherein the single hollow shell is formed with the second material such that the hollow core insert is in a solid form.

6. The bath or hand soap bar shell of claim 1, wherein the second material is a non-soap material.

7. The bath or hand soap bar shell of claim 6, wherein the non-soap material is a recycled paper or a paper product.

8. The bath or hand soap bar shell of claim 1, wherein the second material of the hollow core insert is a paper or a wood or a plastic.

9. The bath or hand soap bar shell of claim 1, wherein the first soap piece is solid when joined with the second soap piece.

10. The bath or hand soap bar shell of claim 1, wherein the second soap piece is solid when joined with the first soap piece.

11. The bath or hand soap bar shell of claim 1, wherein the hollow core insert having a volume which is selected to give the bath or hand soap bar shell about 40% to 60% less weight as compared to a solid bath or hand soap bar of a same size.

12. The bath or hand soap bar shell of claim 1, wherein the hollow core insert having a box shape.

13. The bath or hand soap bar shell of claim 1, wherein the hollow core insert having an oval shape.

14. The bath or hand soap bar shell of claim 1, wherein the second material is a non-meltable material such that the hollow core insert is in a solid form.

15. The bath or hand soap bar shell of claim 1, wherein the second soap portion is joined to the first soap portion by a molten soap material forming a joint therebetween.

16. A method for producing a bath or hand soap bar shell, the method comprising:
pouring a meltable soap material into a mold cavity;
forming a first soap piece in the mold cavity from the meltable soap material;
positioning a hollow core insert formed from a non-soap material on the first soap piece;
pouring the meltable soap material into the mold cavity to form a second soap piece; and
applying the second soap piece to the first soap piece as a molten soap material forming an adhesive interface therebetween when the first soap piece and the second soap piece are brought into contact with each other.

17. The method of claim 16, wherein applying the second soap piece to the first soap piece further comprising:
encasing the hollow core insert fully within the bath or hand soap bar shell.

18. The method of claim 16, wherein the hollow core insert comprising a single hollow shell.

19. The method of claim 18, wherein the single hollow shell is in a solid form.

20. The method of claim 16, wherein the non-soap material is a recycled paper or a paper product.
